(19) United States
(12) Patent Application Publication
(10) Pub. No.: US 2014/0253918 A1
(43) Pub. Date: Sep. 11, 2014

(54) RAMAN SCATTERING MEASURING APPARATUS AND RAMAN SCATTERING MEASURING METHOD

(71) Applicant: CANON KABUSHIKI KAISHA, Tokyo (JP)

(72) Inventors: Yasuyuki OZEKI, Kawasaki-shi (JP); Kazuyoshi ITOH, Kawanishi-shi (JP); Keisuke NOSE, Tokyo (JP)

(73) Assignee: CANON KABUSHIKI KAISHA, Tokyo (JP)

(21) Appl. No.: 14/198,979

(22) Filed: Mar. 6, 2014

(30) Foreign Application Priority Data
Mar. 8, 2013 (JP) 2013-046362

(51) Int. Cl. G01J 3/44

(52) U.S. Cl. CPC G01J 3/4412
USPC 356/301

(57) ABSTRACT

The Raman scattering measuring apparatus includes a first light generator to produce a first light, a second light generator to produce a second light having a frequency different from that of the first light, an optical system to focus the first and second lights to a sample, and a detector to detect the first or second light intensity-modulated by Raman scattering. The first light generator includes a wavelength extractor that performs a wavelength filtering to extract light of an extraction wavelength from light in a wavelength range including the extraction wavelength and an amplification of the light extracted by the wavelength filtering. The wavelength extractor performs a first filtering on an entering light, a first amplification on the light extracted by the first filtering, a second filtering on the light amplified by the first amplification and a second amplification on the light extracted by the second filtering.

### BACKGROUND OF THE INVENTION

1. Field of the Invention

The present invention relates to a Raman scattering measuring apparatus and a Raman scattering measuring method each of which performs molecular vibration imaging by utilizing Raman scattering, the apparatus and method being particularly suitable for a microscope, an endoscope and the like.

2. Description of the Related Art

As a measuring apparatus utilizing a Raman scattering principle, a stimulated Raman scattering (SRS) measuring apparatus has been proposed in F. Dake, Y. Ozeki, and K. Itoh, “Principle confirmation of stimulated Raman scattering microscopy,” Optics & Photonics Japan (2008), 5pC12, Nov. 5, 2008 (hereinafter referred to as “Document 1”) and Chiristian W. Freudiger, Wei Min, Brian G. Saar, Sijia Lu, Gary R. Holtom, Chengwei He, Jason C. Tsai, Jing X. Kang, X. Sunney Xie, “Label-Free Biomedical Imaging with High Sensitivity by Stimulated Raman Scattering Microscopy” SCIENCE VOL322 19 Dec. 2008 pp. 1857-1861 (hereinafter referred to as “Document 2”). In the stimulated Raman scattering measuring apparatus, two pulsed lights whose wavelengths are mutually different are focused to a sample. Coincidence of a difference between frequencies of the two pulsed lights with a molecular vibration frequency of the sample causes a phenomenon of stimulated Raman scattering at a light-focused point. The stimulated Raman scattering decreases intensity of one of the two pulsed lights which has a higher frequency (that is, has a shorter wavelength) and increases intensity of the other one which has a lower frequency (that is, has a longer wavelength). Detection of such intensity changes enables molecular vibration imaging in which vibration information of molecules of the sample is reflected.

For such a stimulated Raman scattering measuring apparatus, it is expected that its discrimination ability for the sample may be further improved, not only by detecting the molecular vibration only by using a specific wavelength, but also by detecting a molecular vibration spectrum (hereinafter referred to as “a Raman spectrum”) in a wide wavelength range.

On the other hand, the present inventers have proposed, in Y. Ozaki, W. Umemura, K. Sumimura, N. Nishizawa, K. Fukui and K. Itoh “Stimulated Raman hyperspectral imaging based on spectral filtering of broadband fiber laser pulses” Opt. Lett. 37, 431 (2012) (hereinafter referred to as “Document 3”), a configuration which extracts part of a spectrum of a broadband fiber laser by a wavelength tunable band-pass filter and amplifies the extracted light by two-step optical amplifiers to generate a pulsed light whose wavelength is tunable (variable).

However, the configuration proposed in Document 3 includes a problem that a wavelength range of an obtainable pulsed light is restricted. FIG. 9 schematically shows constituent elements (in a lower part) in the configuration proposed in Document 3 and light (in an upper part) emitted from each of the constituent elements. Laser light (shown by FL in the upper part) emitted from a Yb fiber laser (YbFL) as a light source is introduced to a wavelength tunable band-pass filter (TBPF). A horizontal axis in the upper part of FIG. 9 shows wavelength λ, and a vertical axis therein shows intensity I. The wavelength tunable band-pass filter extracts, from an entering laser beam, a light of a specific wavelength which should be extracted as a pulsed light (the light of the specific wavelength is hereinafter referred to also as “an extracted light” and shown by PLS in the upper part). Changing (scanning) the wavelength of the light to be extracted makes it possible to provide an extracted light in a wavelength range corresponding to that of the light source.

The extracted light exiting from the wavelength tunable band-pass filter is amplified by a Yb-doped fiber amplifier as a first step optical amplifier (AMP1). However, this optical amplifier amplifies not only the extracted light, but also a spontaneous emission light generated in the optical amplifier. That is, a light exiting from the first step optical amplifier includes not only the amplified extracted light, but also the amplified spontaneous emission light (hereinafter referred to as “an ASE light”). The ASE light is generated in a wide wavelength range regardless of the wavelength of the extracted light, and its peak appears at a gain central wavelength of the optical amplifier. This also applies to a Yb-doped fiber amplifier as a second step optical amplifier (AMP2) where the light exiting from the first step optical amplifier enters. Therefore, a light exiting from the second optical amplifier includes not only the amplified extracted light, but also the ASE light generated in the first step optical amplifier and amplified by the second step optical amplifier and another ASE light generated in the second step optical amplifier.

FIG. 10A shows intensity change of the light exiting from the first step optical amplifier (AMP1) when scanning a wavelength (hereinafter referred to as “an extraction wavelength”) extracted by the wavelength tunable band-pass filter. A horizontal axis in FIG. 10A shows the extraction wavelength λ, and a vertical axis therein shows intensity I. Although the extraction wavelength λ strictly means a central wavelength of the extracted light in view of a wavelength width of the extracted light, since the following description will be made without taking the wavelength width into consideration, the extraction wavelength is used herein. The intensity of the extracted light (PLS) changes with wavelength according to a wavelength-gain characteristic of the first step optical amplifier. On the other hand, the ASE light has a constant intensity as intensity in the whole wavelength band where the ASE light is generated, regardless of change of the extraction wavelength.

FIG. 10B shows the light exiting from the second step optical amplifier (AMP2) where the light exiting from the first step optical amplifier (AMP1), which is shown in FIG. 10A, has entered. The second step optical amplifier amplifies the entering light in a state where a gain is saturated so that equal outputs can be obtained in a wavelength range as wide as possible in its amplifying wavelength band. In FIG. 10B, ASE1 represents intensity of the ASE light generated in the first step optical amplifier and amplified by the second step optical amplifier, and ASE2 represents intensity of the ASE light generated in the second step optical amplifier. As shown in FIG. 10B, according to the change of the intensity of the extracted light with respect to the wavelength shown in FIG. 10A, a ratio of the intensity of the extracted light (PLS) and a ratio of the intensity of the ASE light (ASE1 and ASE2) to a saturation level change with the extraction wavelength.

On the other hand, as mentioned above, the constant ASE light is generated in the first step optical amplifier regardless of the extraction wavelength. Therefore, a ratio of the ASE light to the extracted light included in output from the second step optical amplifier is larger in a wavelength band where the gain is lower than that in the gain central wavelength band of that optical amplifier. Thus, as shown in FIG. 10C, intensity of the extracted light included in the light exiting from the second step optical amplifier (AMP2) becomes low in wavelength bands on both sides of its peak intensity wavelength. Therefore, an effective wavelength range that is a wavelength range of an effective extracted light which can be used as an effective pulsed light to be focused to the sample becomes a significantly narrower range than a narrow wavelength range W′ around the peak intensity wavelength, that is, the amplifying wavelength band that the second step optical amplifier originally has.

### SUMMARY OF THE INVENTION

The present invention provides a Raman scattering measuring apparatus and a Raman scattering measuring method each capable of widening a wavelength range where a sufficient intensity of light to be focused to a sample is obtained when amplifying the light by two-step amplification.

The present invention provides as one aspect thereof a Raman scattering measuring apparatus including a first light generator configured to produce a first light, a second light generator configured to produce a second light having a wavelength different from that of the first light, an optical system configured to focus the first and second lights to a sample, and a detector configured to detect the first or second light intensity-modulated by Raman scattering caused by the focusing of the first and second lights to the sample. The first light generator includes a wavelength extractor configured to perform a wavelength filtering to extract light of an extraction wavelength from light in a wavelength range including the extraction wavelength and an amplification of the light extracted by the wavelength filtering. The wavelength extractor is configured to perform a first filtering as the wavelength filtering on an entering light, a first amplification as the amplification on the light extracted by the first filtering, a second filtering as the wavelength filtering on the light amplified by the first amplification, and a second amplification as the amplification on the light extracted by the second filtering.

The present invention provides as another aspect thereof a Raman scattering measuring method including a focusing step of focusing a first light and a second light having a wavelength different from that of the first light to a sample, and a detecting step of detecting the first or second light intensity-modulated by Raman scattering caused by the focusing of the first and second lights to the sample. The focusing step includes a wavelength extracting step of performing a wavelength filtering to extract light of an extraction wavelength from light in a wavelength range including the extraction wavelength and an amplification of the light extracted by the wavelength filtering. The wavelength extracting step includes performing a first filtering as the wavelength filtering on an entering light, performing a first amplification as the amplification on the light extracted by the first filtering, performing a second filtering as the wavelength filtering on the light amplified by the first amplification and performing a second amplification as the amplification on the light extracted by the second filtering.

Further features of the present invention will become apparent from the following description of exemplary embodiments (with reference to the attached drawings).

### BRIEF DESCRIPTION OF THE DRAWINGS

FIG. 1 is a block diagram showing a configuration of an SRS measuring apparatus that is Embodiment 1 of the present invention.

FIG. 2 schematically shows a configuration of a wavelength extractor of the SRS measuring apparatus of Embodiment 1 and shows outputs of respective steps of the wavelength extractor.

FIGS. 3A to 3D show outputs obtained by the wavelength extractor.

FIG. 4 shows an example of a measurement result obtained by the SRS measuring apparatus of Embodiment 1.

FIG. 5 shows a specific configuration of the wavelength extractor.

FIG. 6 shows another specific configuration of the wavelength extractor.

FIG. 7 shows a configuration of a wavelength tunable band-pass filter used for the wavelength extractor in Embodiment 1.

FIGS. 8A to 8C show specific configurations of a wavelength extractor in an SRS measuring apparatus that is Embodiment 2 of the present invention.

FIG. 9 schematically shows a configuration of a wavelength extractor of a conventional SRS measuring apparatus and shows outputs of respective steps of the wavelength extractor.

FIGS. 10A to 10C show outputs obtained by the wavelength extractor in the conventional SRS measuring apparatus.

### DESCRIPTION OF THE EMBODIMENTS

Exemplary embodiments of the present invention will hereinafter be described with reference to the accompanying drawings.

### Embodiment 1

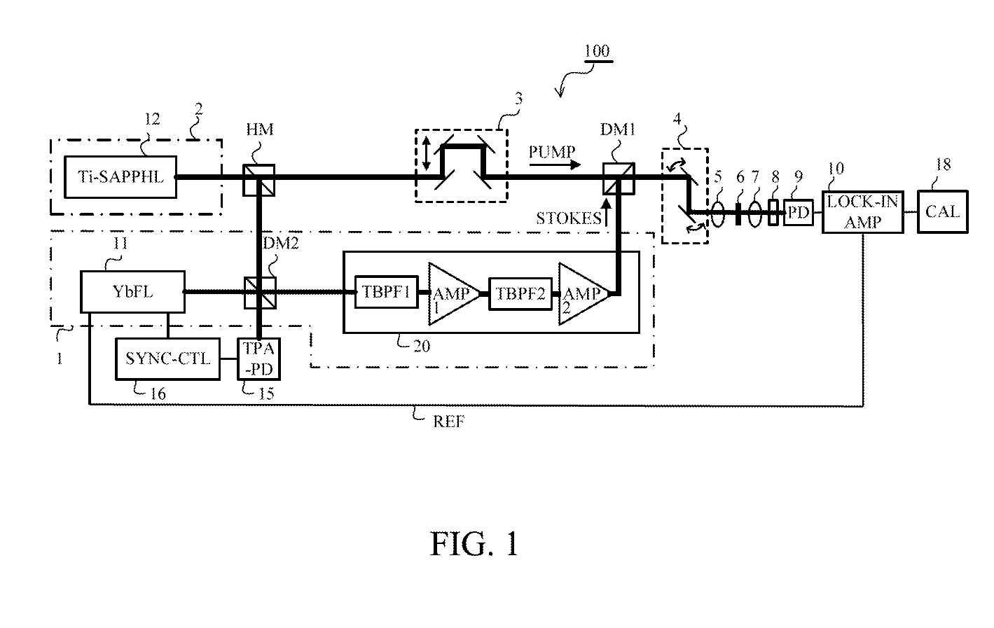

FIG. 1 schematically shows a configuration of a stimulated Raman scattering (SRS) measuring apparatus that is a first embodiment (Embodiment 1) of the present invention. The SRS measuring apparatus 100 of this embodiment can be used as apparatuses, such as a microscope and an endoscope, for observation, measurement, diagnosis and other usages.

The SRS measuring apparatus 100 of this embodiment includes a first pulsed light generator 1 configured to produce a first pulsed light (first light) to be used as a Stokes light and a second pulsed light generator 2 configured to produce a second pulsed light (second light) to be used as a pump light. Moreover, the measuring apparatus 100 includes a two-photon absorption photodiode (TPA-PD) 15 and a synchronization controller 16, which are provided to control light-emitting timings of light sources (described later) provided in the first and second pulsed light generators 1 and 2.

In addition, the measuring apparatus 100 includes a half mirror HM, a delay optical path 3, a first dichroic mirror (light combining element) DM1 and a second dichroic mirror DM 2. The measuring apparatus 100 further includes an XY scanner 4, a first objective optical system (objective lens) 5, a second objective optical system (collimator lens) 7, a color filter 8, a photo detector (photo diode) 9, a lock-in amplifier 10 and a calculating unit 18. A sample 6 that is an object to be measured is placed between the first objective optical system 5 and the second objective optical system 7.

The first pulsed light generator 1 is constituted by a first light source 11 and a wavelength extractor (wavelength tunable amplifier) 20. The first light source 11 repetitively emits a pulsed light with a first pulse period and is constituted by a Yb fiber laser (YbFL) in this embodiment. The pulsed light emitted from the first light source 11 has, for example, a central wavelength of 1030 nm and a repetition frequency νₛ of 38 MHz. The pulsed light emitted from the first light source 11 is reflected by the second dichroic mirror DM 2 to be introduced to the TPA-PD 15.

The wavelength extractor 20 is constituted by at least one wavelength tunable band-pass filter (TBPF) and at least one optical amplifier (AMP). The wavelength tunable band-pass filter is capable of tuning a wavelength of light to be extracted (hereinafter referred to as “an extraction wavelength”), that is, a frequency of the light to be extracted. The wavelength extractor 20 performs a wavelength tunable filtering (wavelength filtering) to extract a light of a wavelength corresponding to the extraction wavelength of the wavelength tunable band-pass filter from an entering light (that is, a light in a wavelength range including the extraction wavelength). In the following description, this wavelength tunable filtering is also simply referred to as “a filtering.”

Moreover, the wavelength extractor 20 amplifies the light extracted by the filtering, by using the optical amplifier. Thereby, the first pulsed light whose wavelength is tunable and whose intensity is amplified exits from the wavelength extractor 20 (that is, from the first pulsed light generator 1). A configuration and functions of the wavelength extractor 20 will be later described in detail. The first pulsed light exiting from the first pulsed light generator 1 is introduced to the first dichroic mirror DM1.

The second pulsed light generator 2 includes a second light source 12 and an optical amplifier (not illustrated). The second light source 12 repetitively emits a pulsed light with a second pulse period and is constituted by a titanium-sapphire laser (Ti-SAPPHL) in this embodiment. The pulsed light emitted from the second light source 12 has a central wavelength of 790 nm, which is different from that of the pulsed light emitted from the first light source 11, and has a repetition frequency 2νₛ of 76 MHz. The optical amplifier (not illustrated) amplifies the pulsed light emitted from the second light source 12 to output the amplified pulsed light as the second pulsed light.

In this embodiment, the repetition frequency of the first pulsed light is set to ½ of that of the second pulsed light. Thus, each light pulse of the first pulsed light is generated synchronously with a timing of generation of two light pulses of the second pulsed light. The repetition frequency of the first pulsed light is not limited to ½ of that of the second pulsed light, that is, may be set to ⅓, ¼ or others of that of the second pulsed light. However, setting the repetition frequency of the first pulsed light to ½ of that of the second pulsed light makes it possible to increase the number of times of causing a stimulated Raman scattering effect, as compared with a case of setting the repetition frequency of the first pulsed light to ⅓, ¼ or others of that of the second pulsed light, which enables acquisition of a molecular vibration image of the sample 6 with a higher accuracy.

Part of the second pulsed light exiting from the second pulsed light generator 2 is reflected by the half mirror HM and is transmitted through the second dichroic mirror DM 2 to be introduced to the TPA-PD 15. The TPA-PD 15 photoelectrically converts the entering first and second pulsed lights to output a voltage signal showing a timing difference of these pulsed lights. The voltage signal showing the timing difference is input to the synchronization controller 16. The synchronization controller 16 controls emission timings of the first and second light sources 11 and 12 so that the input voltage signal becomes constant at a predetermined value (that is, so that the above-mentioned synchronous timing of the first and second pulsed lights can be obtained).

Although the Yb fiber laser light source and the titanium-sapphire laser light source are used as the first and second light sources 11 and 12 in this embodiment, other laser light sources, such as an Er fiber laser light source, may be used.

Moreover, although description of this embodiment is made of the case where, of the first and second pulsed lights, the first pulsed light with a lower repetition frequency as the Stokes light and the second pulsed light with a higher repetition frequency is used as the pump light, the first pulsed light with a lower repetition frequency may be used as the pump light and the second pulsed light with a higher repetition frequency may be used as the Stokes light.

The delay optical path 3 is constituted by four mirrors and changes intervals among the mirrors to change an optical path length of the second pulsed light emitted from the second light source 12 (that is, exiting from the second pulsed light generator 2). This optical path length is changed so that the first and second pulsed lights (light pulses thereof) may be simultaneously focused to the sample 6. The second pulsed light exiting from the second pulsed light generator 2 is introduced to the first dichroic mirror DM1 to be combined thereby concentrically with the first pulsed light exiting from the first pulsed light generator 1. The combined pulsed lights are focused on the sample 6 through the XY scanner 4 and the first objective optical system 5. The first dichroic mirror DM1, the XY scanner 4 and the first objective optical system 5 constitute an optical system which combines the first pulsed light with the second pulsed light to focus the combined pulsed lights to the sample 6.

When the repetition frequencies of the first and second pulsed lights focused to the sample 6 are respectively represented by νₛ and 2νₛ, both the first and second pulsed lights and only the second pulsed light are alternately focused to the sample 6 at every time interval of 1/(2νₛ). The focusing of both the first and second pulsed lights to the sample 6 in a state where a difference between the frequencies of the first and second pulsed lights coincides with a molecular vibration frequency of molecules to be measured in the sample 6 (at every time interval of 1/νₛ) causes stimulated Raman scattering. The stimulated Raman scattering causes intensity modulation of the second pulsed light with a frequency of νₛ.

The first pulsed light exiting from the sample 6 and the second pulsed light intensity-modulated by the stimulated Raman scattering and exiting therefrom are collimated by the second objective optical system 7 and enter the color filter 8. Then, only the second pulsed light is transmitted through the color filter 8 to enter the photo detector 9.

The photo detector 9 converts the entering second pulsed light into an electrical signal corresponding to light intensity of the second pulsed light. The electrical signal output from the photo detector 9 is input to the lock-in amplifier 10 to be synchronously detected thereby with a lock-in frequency which is a frequency νₛ of a reference signal REF synchronizing with the first pulsed light from the first pulsed light generator 1 (first light source 11). This synchronous detection by the lock-in amplifier 10 detects only an intensity-modulated component of the second pulsed light generated by the stimulated Raman scattering. The photo detector 9 and the lock-in amplifier 10 constitute a detector.

The XY scanner 4 scans a light focusing area for the sample 6 where the pulsed light exiting from the first dichroic mirror DM1 is focused, two-dimensionally (in X and Y directions). This scanning enables the calculating unit 18 taking in output from the lock-in amplifier 10 to acquire a molecular vibration image of the molecules to be measured in the sample 6. Changing (scanning) the wavelength of the first pulsed light enables continuously changing the frequency difference between the first and second pulsed lights, so that a Raman spectrum can be acquired in a continuous wavelength range.

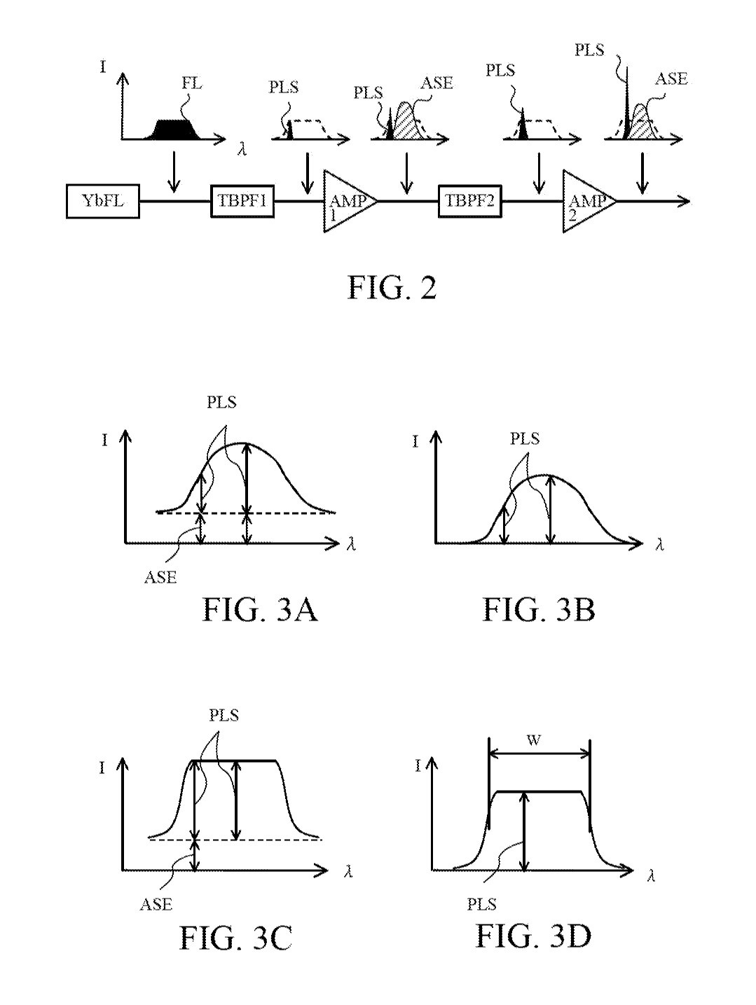

Next, description will be made of a basic configuration and functions of the wavelength extractor with reference to FIGS. 2 and 3. FIG. 2 schematically shows, in its lower part, basic constituent elements of the wavelength extractor 20 and shows, in its upper part, light exiting from each constituent element.

As shown in FIG. 2, a laser beam (shown in the upper part in the figure by FL) as a raw light emitted from the Yb fiber laser (YbFL) which is the first light source 11 is introduced to a first wavelength tunable band-pass filter (TBPF1) that performs a first filtering as the filtering in the wavelength extractor 20. A horizontal axis in the upper part of FIG. 2 shows wavelength λ, and a vertical axis therein shows intensity I. The first wavelength tunable band-pass filter extracts, from the entering laser beam, a light of a wavelength corresponding to the extraction wavelength of the first wavelength tunable band-pass filter (the light is hereinafter referred to as “an extracted light” and shown in the upper part of FIG. 2 by PLS). Changing (scanning) the extraction wavelength of the first wavelength tunable band-pass filter provides the extracted light in a wavelength range corresponding to that of the raw light.

Next, as shown in FIG. 2, the extracted light provided by the first filtering is amplified by a Yb-doped fiber amplifier as a first optical amplifier (AMP1) that performs a first amplification (first step amplification). As mentioned above, from this first optical amplifier, not only the amplified extracted light exits, but also the ASE light generated in this optical amplifier exits.

FIG. 3A shows an exiting light from the first optical amplifier when the extracted light provided by scanning the extraction wavelength of the first wavelength tunable band-pass filter enters the first optical amplifier. A horizontal axis in FIG. 3A shows the extraction wavelength λ, and a vertical axis therein shows intensity I. The intensity of the extracted light (PLS) changes with wavelength according to a wavelength-gain characteristic of the first step optical amplifier. The ASE light has a constant intensity as intensity in the whole wavelength band where the ASE light is generated, regardless of change of the wavelength of the extracted light.

Moreover, as shown in FIG. 2, the exiting light from the first optical amplifier is introduced to a second wavelength tunable band-pass filter (TBPF2) that performs a second filtering as the filtering. In this configuration, it is important that the extraction wavelength in the first filtering (that is, of the first wavelength tunable band-pass filter) and that in the second filtering (that is, of the second wavelength tunable band-pass filter) coincide with each other. The coincidence thereof enables removal of the ASE light from the exiting light from the first optical amplifier, and thereby only the extracted light having the same wavelength as the extraction wavelength in the first filtering and amplified by the first optical amplifier exits from the second wavelength tunable band-pass filter.

FIG. 3B shows the exiting light from the second wavelength tunable band-pass filter provided by scanning the extraction wavelength of the second wavelength tunable band-pass filter. The extraction wavelength of the second wavelength tunable band-pass filter always coincides, during the scanning thereof, with the extraction wavelength scanned in the first wavelength tunable band-pass filter. Therefore, only the extracted light included in the exiting light from the first optical amplifier shown in FIG. 3A is output from the second wavelength tunable band-pass filter, almost without decrease in its intensity.

Then, as shown in FIG. 2, the extracted light provided by the second filtering is amplified by a Yb-doped fiber amplifier as a second optical amplifier (AMP2) that performs a second amplification (second step amplification). In the second step amplification, as shown in FIG. 3C, amplification of an entering light is performed so that its intensity may become a saturation level in a wide wavelength range of its amplification wavelength band. Although an ASE light is also generated in this second optical amplifier, its intensity is equivalent to that of the ASE light generated in the first optical amplifier; the intensity is smaller than that of the extracted light after the second step amplification. Thus, as also shown in FIG. 3D, from the second optical amplifier, an extracted light whose output is approximately constant in the wide wavelength range W of its amplification wavelength band and which has a sufficient intensity is provided. In other words, an extracted light having a sufficient intensity is provided in a wider wavelength range W than the wavelength range W′ where the extracted light having a sufficient intensity is provided in the conventional configuration shown in FIG. 10C (Document 3).

Thus, the measuring apparatus of this embodiment performs, when obtaining the first pulsed light to be focused to the sample 6 by performing the first and second amplifications (two-step amplification) with changing the wavelength, the second amplification after removing the ASE light generated in the first amplification by the second filtering.

Therefore, the measuring apparatus of this embodiment can widen the wavelength range where a sufficient intensity of the first pulsed light after the second amplification is obtained, as compared with the conventional configuration.

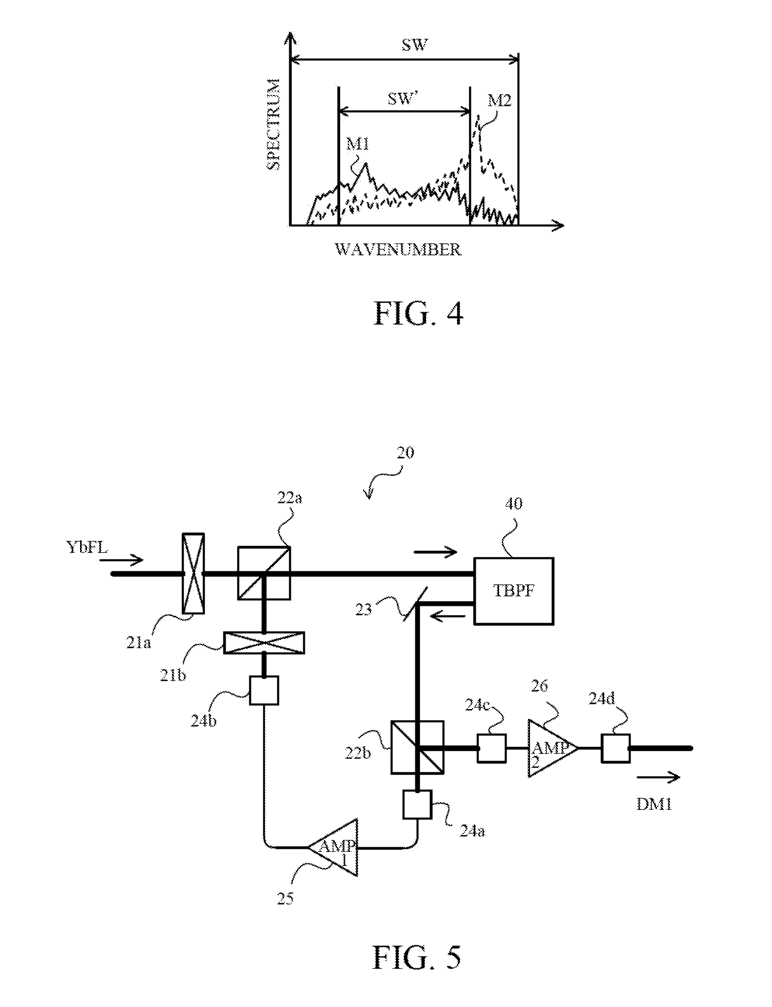

FIG. 4 schematically shows a difference between a Raman spectrum obtained for a sample by a conventional SRS measuring apparatus having the conventional configuration and a Raman spectrum obtained for the same sample by the SRS measuring apparatus of this embodiment. In the conventional SRS measuring apparatus, the Raman spectrum is obtained in a wavenumber range SW′ corresponding to the wavelength range W′ of the extracted light shown in FIG. 10C. In this wavenumber range SW′, of Raman spectra of molecules M1 and M2 included in the sample, only the Raman spectrum of the molecule M1 appears as a Raman spectrum whose characteristic can be detected. That is, it is difficult to detect the Raman spectrum of the molecule M2 whose characterizing portion exists outside the wavenumber range SW′.

On the other hand, in the SRS measuring apparatus of this embodiment, the Raman spectrum is obtained in a wavenumber range SW corresponding to the wavelength range W of the extracted light shown in FIG. 3D and being wider than the wavenumber range SW′. In this wavenumber range SW, in addition to the Raman spectrum of the molecule M1, the characterizing portion of the Raman spectrum of the molecule M2 can also be detected. Thus, the SRS measuring apparatus of this embodiment can further improve discrimination ability of samples as compared with the conventional SRS measuring apparatus.

FIG. 5 shows a more desirable configuration to realize the above described functions of the wavelength extractor 20. The first wavelength tunable band-pass filter (TBPF1), the first amplifier (AMP1), the second wavelength tunable band-pass filter (TBPF2) and the second amplifier (AMP2) which constitute the wavelength extractor 20 shown in FIG. 2 may be provided separately from one another. However, such a configuration may make the scanning of the extraction wavelengths of the first and second wavelength tunable band-pass filters difficult while always maintaining the coincidence of these extraction wavelengths.

For this reason, it is desirable to use one same wavelength tunable band-pass filter as the first and second wavelength tunable band-pass filters. In other words, it is desirable to employ a configuration that performs the first filtering by a wavelength tunable band-pass filter to extract light, amplifies the light by the first amplification and then introduces the amplified light again to the wavelength tunable band-pass filter used for the first filtering to perform the second filtering.

In FIG. 5, a pulsed light (linearly polarized light) from the first light source (YbFL) enters a λ/2 plate 21a where its polarization direction is rotated by 90 degrees, is transmitted through a first polarization beam splitter 22a and then enters a wavelength tunable band-pass filter (TBPF) 40. The wavelength tunable band-pass filter 40 performs, as well as the first and second wavelength tunable band-pass filters (TBPF1 and TBPF2), the filtering to extract the light of the wavelength corresponding to the extraction wavelength from the entering light while changing the extraction wavelength. The wavelength tunable band-pass filter 40 performs the first filtering on the pulsed light from the first light source to output an extracted light (hereinafter referred to as “a first extracted light”).

The first extracted light exiting from the wavelength tunable band-pass filter 40 is reflected by a mirror 23, is transmitted through a second polarization beam splitter 22b and then enters, through a fiber collimator 24a, a first optical amplifier (AMP1) 25 constituted by a Yb-doped fiber amplifier. The first optical amplifier 25 performs the first amplification on the entering first extracted light. The first extracted light amplified by the first optical amplifier 25 enters the λ/2 plate 21a through a fiber collimator 24b. Then, the first extracted light whose polarization direction is rotated by 90 degrees by the λ/2 plate 21a is reflected by the first polarization beam splitter 22a and thereafter again enters the wavelength tunable band-pass filter (TBPF) 40.

The wavelength tunable band-pass filter 40 performs the second filtering on the first extracted light after the first amplification to output an extracted light (hereinafter referred to as “a second extracted light”). The second extracted light is reflected by the mirror 23, is reflected by the second polarization beam splitter 22b and then enters, through a fiber collimator 24c, a second optical amplifier (AMP2) 26 constituted by a Yb-doped fiber amplifier. The second optical amplifier 26 performs the second amplification on the entering second extracted light. The second extracted light amplified by the second optical amplifier 26 proceeds, through a fiber collimator 24d, toward the first dichroic mirror DM1 shown in FIG. 1.

As described above, performing the first and second filterings by using the one same wavelength tunable band-pass filter enables the scanning of the extraction wavelengths in the first and second filterings while always maintaining the coincidence of these extraction wavelengths. This configuration makes it possible to surely achieve the functions required for the wavelength extractor 20 with a simpler configuration as compared with the case of using the wavelength tunable band-pass filters separately provided as the first and second wavelength tunable band-pass filters.

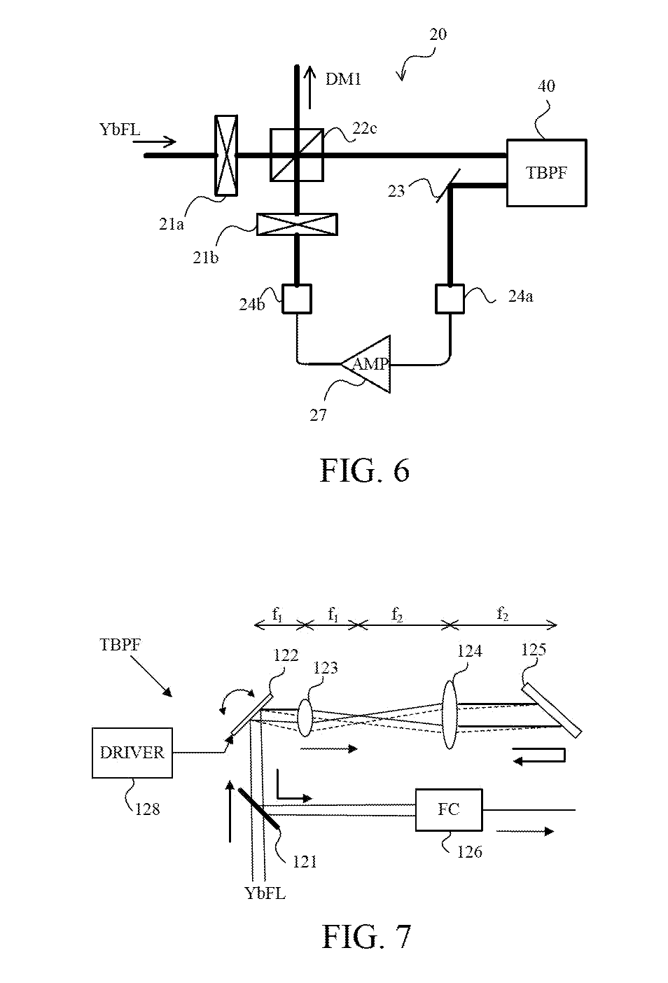

Moreover, as shown in FIG. 6, a configuration may be employed which uses not only the one wavelength tunable band-pass filter, but also one same optical amplifier as the first and second optical amplifiers. In other words, a configuration may be employed which performs the first amplification on an entering light by an optical amplifier and introduces the amplified light to the optical amplifier used for the first amplification to perform the second amplification.

In FIG. 6, a pulsed light (linearly polarized light) from the first light source (YbFL) enters a λ/2 plate 21a where its polarization direction is rotated by 90 degrees 21a, is transmitted through a polarization beam splitter 22c and then enters a wavelength tunable band-pass filter (TBPF) 40. The wavelength tunable band-pass filter 40 has the function described in the configuration shown in FIG. 5 and thereby performs the first filtering on the pulsed light from the first light source to output a first extracted light.

The first extracted light is reflected by a mirror 23 and then enters, through a fiber collimator 24a, an optical amplifier (AMP) 27 constituted by a Yb-doped fiber amplifier. The optical amplifier 27 performs the first amplification on the first extracted light. The first extracted light amplified by the optical amplifier 27 enters a λ/2 plate 21b through a fiber collimator 24b. Then, the first extracted light whose polarization direction is rotated by 90 degrees by the λ/2 plate 21b is reflected by a polarization beam splitter 22c and then again enters the wavelength tunable band-pass filter (TBPF) 40.

The wavelength tunable band-pass filter 40 performs the second filtering on the first extracted light after the first amplification to output a second extracted light. The second extracted light is reflected by the mirror 23 and then again enters the optical amplifier (AMP) 27 through the fiber collimator 24a. The optical amplifier 27 performs the second amplification on the second extracted light.

Thereafter, the second extracted light amplified by the second amplification enters, through the fiber collimator 24b, the λ/2 plate 21b where its polarization direction is rotated by 90 degrees, is transmitted through the polarization beam splitter 22c and then proceeds toward the first dichroic mirror DM1 shown in FIG. 1.

As described above, performing the first filtering, the first amplification, the second filtering and the first amplification by using the one wavelength tunable band-pass filter and the one optical amplifier makes it possible to surely achieve the functions required for the wavelength extractor 20 with a further simpler configuration.

Next, description will be made of a specific configuration of the above-described wavelength tunable band-pass filter (TBPF1 and TBPF2) used for the wavelength extractor 20 with reference to FIG. 7. The wavelength tunable band-pass filter is constituted by an introducing optical system, an optical dispersive element 125, a half mirror 121 and a fiber collimator 126; the introducing optical system is constituted by a movable light deflecting element 122, a first lens 123 and a second lens 124. The first and second lenses 123 and 124 respectively have focal lengths of f1 and f2.

The pulsed light from the first light source (YbFL) is transmitted through the half mirror 121 and then reaches the movable light deflecting element 122. The movable light deflecting element 122 is constituted by an optical element rotatable (or swingable) with a high speed and capable of changing a direction of a leaving (reflected) light, such as a Galvano mirror, a polygon mirror, a resonant scanner or a MEMS (Micro Electro Mechanical Systems) mirror. A driver 128 includes an actuator to rotationally drive the movable light deflecting element 122 and an electrical circuit to drive the actuator.

The pulsed light reflected by the movable light deflecting element 122 passes through the first and second lenses 123 and 124 to be introduced to the optical dispersive element 125. As shown by a solid line and a dashed-dotted line in FIG. 7, an incident angle of the light to the optical dispersive element 125 is changed by a light deflecting effect of the movable light deflecting element 122.

The optical dispersive element 125 splits the reaching light into lights proceeding in different directions depending on their wavelengths and is constituted by a diffraction grating in this embodiment. A direction in which rulings extend (that is, a ruling direction) is a direction vertical to a sheet of FIG. 7. Using dispersion of the diffraction grating can sufficiently decrease a spectrum width of the first pulsed light.

In this embodiment, a distance between the movable light deflecting element 122 and the first lens 123 and a distance between the first lens 123 and its posterior focal point coincide with the focal length f1 of the first lens 123. Moreover, a distance between the second lens 124 and its anterior focal point and a distance between the second lens 124 and the optical dispersive element 125 coincide with the focal length f2 of the second lens 124. Such a configuration constitutes a 4f imaging system. Therefore, regardless of light deflection by the movable light deflecting element 122, the first pulsed light passes through the wavelength tunable band-pass filter in a constant period of time. Accordingly, change of the wavelength of the pulsed light leaving from the optical dispersive element 125 does not shift the timings at which the first and second pulsed lights are focused to the sample.

The pulsed light leaving from the optical dispersive element 125 again passes through the second and first lenses 124 and 123, is again reflected by the movable light deflecting element 122 and then is reflected by the half mirror 121 to enter the fiber collimator 126. Then, of the lights split by the optical dispersive element 125 in the different directions depending on their wavelengths, only a light proceeding in a reverse direction to its reaching direction to the optical dispersive element 125 (that is, a light reflected by Littrow reflection) proceeds, through the fiber collimator 126, toward the optical amplifier (AMP1 and AMP2) in the wavelength extractor 20. The light (wavelength component) reflected by Littrow reflection changes depending on the incident angle of the light reaching the optical dispersive element 125, so that moving the optical dispersive element 125 enables changing the wavelength of the extracted light.

In a case where variation of group delay depending on the wavelength of the pulsed light becomes a problem in the optical amplifier in the wavelength extractor 20, the group delay can be compensated for by changing the distance between the second lens 124 and the optical dispersive element 125. In addition, using the optical amplifier in a state where its gain is saturated enables suppression of variation of the output from the optical amplifier due to the scanning of the wavelength of the pulsed light. Moreover, instead of using the movable light deflecting element 122 shown in FIG. 7, a mirror whose direction is fixed and a rotatable (swingable) optical dispersive element 125 may be used. Also in this case, as well as in the case of rotating the movable light deflecting element 122, rotating the optical dispersive element 125 enables the wavelength scanning.

As described above, the wavelength band-pass filter only has to have a configuration which changes the incident angle of the light to the optical dispersive element that changes the wavelength of the light leaving therefrom depending on the incident angle of the light thereto, by changing a tilt of at least one of the optical dispersive element and an optical element included in the introducing optical system that introduces the light to the optical dispersive element. The term “by changing a tilt of at least one of the optical dispersive element and the optical element” means that a case of changing tilts of both the optical dispersive element and the optical element is included.

The parameters described in the above embodiments, such as the wavelength of the pulsed light and the repetition frequency, are merely examples, and other parameters may be used.

Moreover, although the above embodiment described the case of using the diffraction grating as the optical dispersive element, other optical elements than the diffraction grating, such as a prism, may be used as the optical dispersive element, as long as the optical element is capable of changing the wavelength of the leaving light depending on the incident angle of the reaching light thereto.

### Embodiment 2

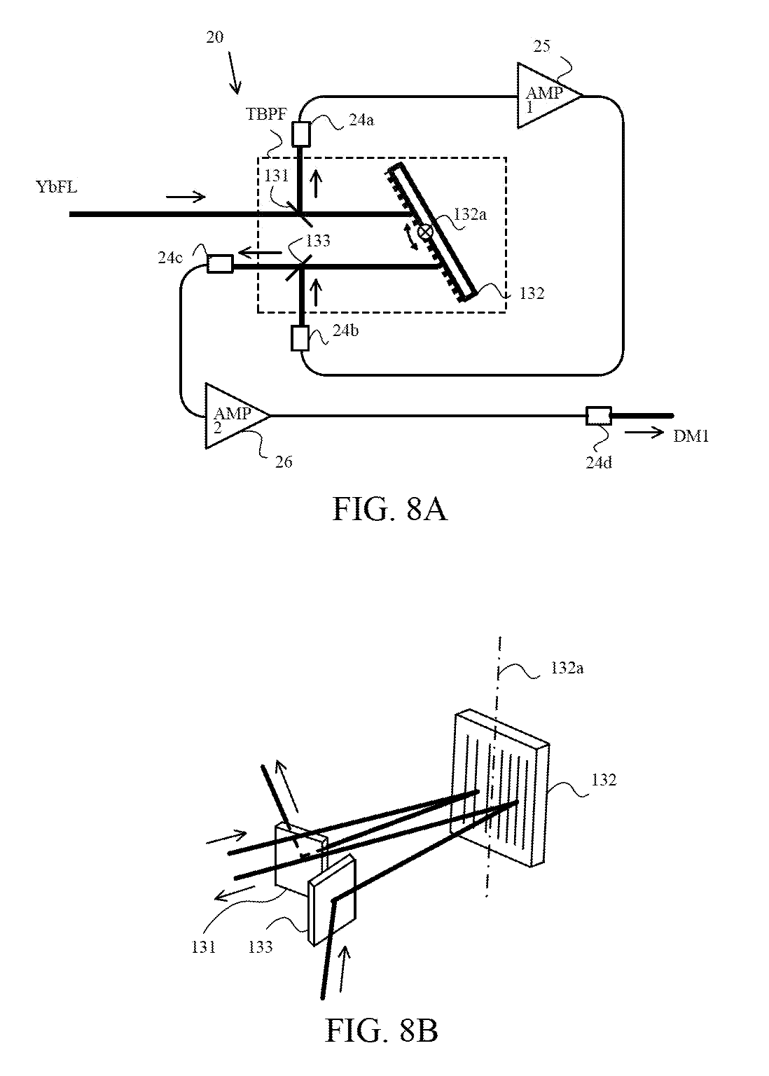

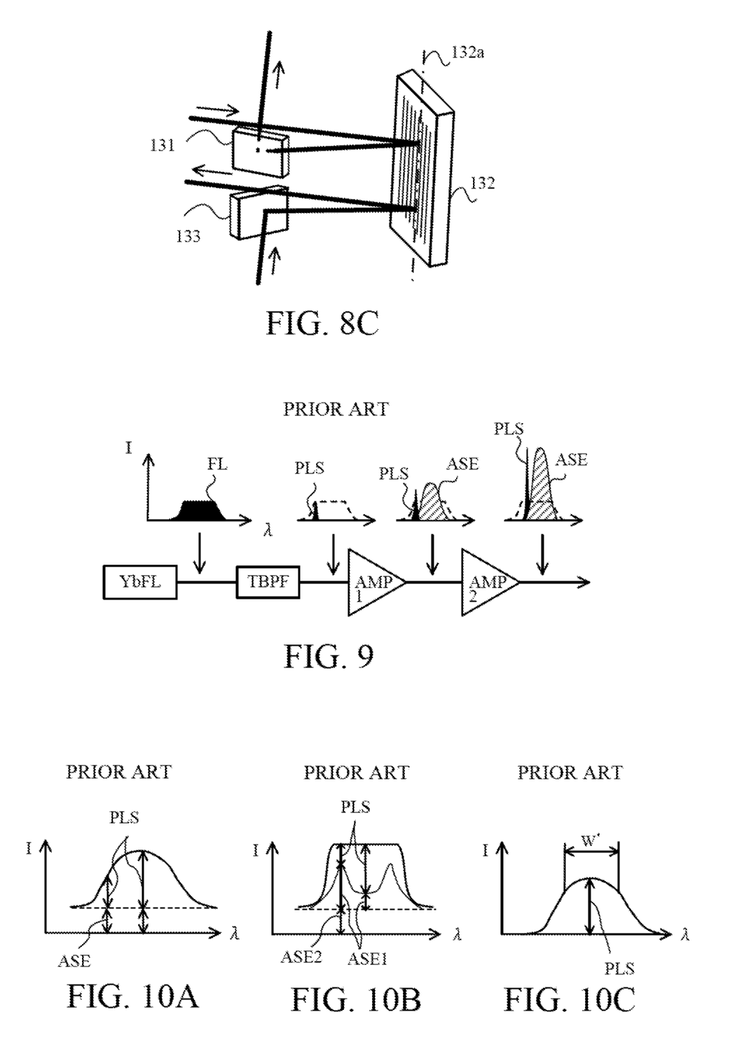

Next, description will be made of a second embodiment (Embodiment 2) of the present invention with reference to FIGS. 8A to 8C. FIG. 8A shows another configuration of the wavelength extractor 20 than those shown in FIGS. 5 and 6.

In FIG. 8A, the pulsed light from the first light source (YbFL) enters, without being reflected by a mirror 131 (that is, via a vicinity of the mirror 131) as shown in FIG. 8B, a diffraction grating 132 as an optical dispersive element constituting the wavelength tunable band-pass filter (TBPF). The diffraction grating 132 splits the reaching light into lights proceeding in different directions depending on their wavelengths.

The diffraction grating 132 is rotatable (swingable) about a rotation center axis 132a by a driver (not shown) and changes an incident angle of the reaching light thereto by its rotation. A ruling direction of the diffraction grating 132 is parallel to a direction in which the rotation center axis 132a extends. Moreover, the rotation center axis 132a of the diffraction grating 132 is slightly tilted about an axis extending in a direction orthogonal to the ruling direction with respect to the mirror 131 (and a mirror 133 described later). The tilt of the rotation center axis 132a enables the light reaching the diffraction grating 132 or leaving therefrom to pass without being reflected by the mirrors 131 and 133.

The diffraction grating 132 performs, by its rotation and its effect of splitting the reaching light into lights proceeding in different directions depending on their wavelengths, the filtering to extract the light of the wavelength corresponding to the extraction wavelength from the reaching light and to change the extraction wavelength. The diffraction grating (wavelength tunable band-pass filter) 132 performs the first filtering on the pulsed light from the first light source (YbFL).

The first extracted light extracted by the first filtering is reflected by the mirror 131 and then enters a first optical amplifier (AMP1) 25 through a fiber collimator 24a. The first optical amplifier 25 performs the first amplification on the entering first extracted light. The first optical amplifier 25 and a second optical amplifier 26 described below are each constituted by a Yb-doped fiber amplifier.

The first extracted light amplified by the first optical amplifier 25 reaches the mirror 133 through a fiber collimator 24b and is reflected thereby to reach the diffraction grating (wavelength tunable band-pass filter) 132 again. The first extracted light reaches the diffraction grating 132 parallel to the pulsed light from the first light source. Then, coincidence of an angle of the diffraction grating 132 in its rotation direction when the first extracted light reaches the diffraction grating 132 to that when the pulsed light from the first light source reaches the diffraction grating 132 enables performing the second filtering on the first extracted light with a same extraction frequency as that in the first filtering.

The second extracted light extracted by the second filtering enters the second optical amplifier (AMP2) 26 through a fiber collimator 24c, without being reflected by the mirror 131 (that is, via a vicinity of the mirror 131). The second optical amplifier 26 performs the second amplification on the entering second extracted light. The second extracted light amplified by the second optical amplifier 26 proceeds toward the first dichroic mirror DM1 shown in FIG. 1 through a fiber collimator 24d.

In this embodiment, an incident (reaching) position of the pulsed light from the first light source to the diffraction grating 132 and an incident position of the first extracted light amplified by the first amplification thereto are different from each other, and the rotation center axis 132a of the diffraction grating 132 is set to pass through an intermediate position (for example, a middle position) of these incident positions. This setting makes it possible to prevent change of an exit timing of the first pulsed light from the wavelength extractor 20 even though the angle of the diffraction grating 132 in its rotation direction is changed.

As shown in FIG. 8C, the rotation center axis 132a of the diffraction grating 132 may be set to pass through both the incident position of the pulsed light from the first light source to the diffraction grating 132 and the incident position of the first extracted light amplified by the first amplification thereto. This setting also makes it possible to prevent change of the exit timing of the first pulsed light from the wavelength extractor 20 even though the angle of the diffraction grating 132 in its rotation direction is changed.

Also in this embodiment, performing the first and second filterings by using the one same wavelength tunable band-pass filter enables the scanning of the extraction wavelengths in the first and second filterings while always maintaining the coincidence of these extraction wavelengths. This configuration makes it possible to surely achieve the functions required for the wavelength extractor 20 with a simpler configuration as compared with the case of using the wavelength tunable band-pass filters separately provided as the first and second wavelength tunable band-pass filters.

Although each of the above embodiments described the case of performing the two-step amplification, alternative embodiments of the present invention may perform at least two-step (for example, three-step) amplification.

Moreover, although each of the above embodiments described the configurations of the measuring apparatus utilizing the stimulated Raman scattering which is one of types of the Raman scattering, the configuration described in each of the above embodiments can apply to measuring apparatuses utilizing other types of the Raman scattering than the stimulated Raman scattering.

Furthermore, for example, in the wavelength tunable band-pass filter in Embodiment 1, instead of using the half mirror 121, a total reflection mirror may be used. In this case, which as well as the configuration shown in FIG. 8B, employing a configuration in which the pulsed light from the first light source (YbFL) passes near the total reflection mirror without being reflected thereby and the extracted light from the optical dispersive element 125 is reflected by the total reflection mirror enables reducing loss of light amount as compared with the case of using the half mirror.

In addition, although each of the above embodiments described the configuration which scans the wavelength, a configuration which extracts only light of one certain wavelength can provide a similar effect to that of each of the above embodiments (that is, an effect of extracting the light having a sufficient intensity from the wavelength range where a sufficient intensity cannot be obtained due to the ASE light in the conventional configuration).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-046362, filed Mar. 8, 2013, which is hereby incorporated by reference herein in its entirety.

What is claimed is:

1. A Raman scattering measuring apparatus comprising:
a first light generator configured to produce a first light;
a second light generator configured to produce a second light having a wavelength different from that of the first light;
an optical system configured to focus the first and second lights to a sample; and
a detector configured to detect the first or second light intensity-modulated by Raman scattering caused by the focusing of the first and second lights to the sample,
wherein the first light generator includes a wavelength extractor configured to perform (a) a wavelength filtering to extract light of an extraction wavelength from light in a wavelength range including the extraction wavelength and (b) an amplification of the light extracted by the wavelength filtering, and
wherein the wavelength extractor is configured to perform:
a first filtering as the wavelength filtering on an entering light;
a first amplification as the amplification on the light extracted by the first filtering;
a second filtering as the wavelength filtering on the light amplified by the first amplification; and
a second amplification as the amplification on the light extracted by the second filtering.

2. A Raman scattering measuring apparatus according to claim 1,
wherein the wavelength extractor performs the amplification by using an optical amplifier and amplifies intensity of the light extracted by the second filtering so that the intensity reaches a saturation level.

3. A Raman scattering measuring apparatus according to claim 2,
wherein the intensity of the light amplified by the first amplification is different depending on the extraction wavelength.

4. A Raman scattering measuring apparatus according to claim 1,
wherein the extraction wavelengths in the first and second filterings coincide with each other.

5. A Raman scattering measuring apparatus according to claim 1,
wherein the wavelength extractor changes the extraction wavelengths in the first and second filterings while maintaining coincidence of these extraction wavelengths.

6. A Raman scattering measuring apparatus according to claim 1,
wherein the wavelength extractor performs the first and second filterings by using a same band-pass filter.

7. A Raman scattering measuring apparatus according to claim 1,
wherein the wavelength extractor performs the first and second amplifications by using a same optical amplifier.

8. A Raman scattering measuring apparatus according to claim 1,
wherein the first light generator includes a fiber laser, and the wavelength extractor includes a fiber amplifier performing the amplification.

9. A Raman scattering measuring apparatus according to claim 1,
wherein the wavelength extractor performs the wavelength filtering by using a band-pass filter whose extraction wavelength is tunable,
wherein the band-pass filter includes an optical dispersive element to split the light in the wavelength range including the extraction wavelength into lights of respective wavelengths and an introducing optical system to introduce the light in the wavelength range including the extraction wavelength to the optical dispersive element, and
the band-pass filter changes an incident angle of the light in the wavelength range including the extraction wavelength to the optical dispersive element by driving at least one of the optical dispersive element and an optical element including the introducing optical system and extracts part of the lights split by the optical dispersive element to change the extraction wavelength.

10. A Raman scattering measuring apparatus according to claim 9,
wherein:
the wavelength extractor performs the second filtering by introducing the light amplified by the first amplification to the band-pass filter used for the first filtering,
the optical dispersive element is configured to be rotatable about an rotation axis; and
the rotation axis is set to pass through an intermediate position between a first incident position at which the light reaches the optical dispersive element in the first filtering and a second incident position at which the light reaches the optical dispersive element in the second filtering or to pass through both the first and second incident positions.

11. A Raman scattering measuring method comprising:
a focusing step of focusing a first light and a second light having a frequency different from that of the first light to a sample; and
a detecting step of detecting the first or second light intensity-modulated by Raman scattering caused by the focusing of the first and second lights to the sample,
wherein the focusing step includes a wavelength extracting step of performing (a) a wavelength filtering to extract light of an extraction wavelength from light in a wavelength range including the extraction wavelength and (b) an amplification of the light extracted by the wavelength filtering, and
wherein the wavelength extracting step includes:
performing a first filtering as the wavelength filtering on an entering light;
performing a first amplification as the amplification on the light extracted by the first filtering;
performing a second filtering as the wavelength filtering on the light amplified by the first amplification; and
performing a second amplification as the amplification on the light extracted by the second filtering.

12. A Raman scattering measuring method according to claim 11,
wherein, in the wavelength extracting step, the second amplification amplifies intensity of the light extracted by the second filtering so that the intensity reaches a saturation level.

13. A Raman scattering measuring method according to claim 12,
wherein, in the wavelength extracting step, the intensity of the light amplified by the first amplification is different depending on the extraction wavelength.

14. A Raman scattering measuring method according to claim 11,
wherein, in the wavelength extracting step, the extraction wavelengths in the first and second filterings coincide with each other.

15. A Raman scattering measuring method according to claim 11,
wherein, in the wavelength extracting step, the extraction wavelengths in the first and second filterings are changed while coincidence of these extraction wavelengths is maintained.
